(19) United States
(12) Patent Application Publication
(10) Pub. No.: US 2016/0367918 A1
(43) Pub. Date: Dec. 22, 2016

(54) FILTER SYSTEM

(71) Applicant: FUJI ELECTRIC CO., LTD., Kanagawa (JP)

(72) Inventor: Wataru SENJYU, Tokyo (JP)

(21) Appl. No.: 15/058,270

(22) Filed: Mar. 2, 2016

(30) Foreign Application Priority Data
Jun. 22, 2015 (JP) 2015-124866

(51) Int. Cl. B01D 29/92; B01D 29/56

(52) U.S. Cl. CPC B01D 29/92; B01D 29/56

(57) ABSTRACT

A filter system provided in a flow channel through which fluid flows, includes a first filter portion in which a plurality of pillars are arranged in parallel; and a second filter portion, provided downstream of the first filter portion in a flowing direction of the fluid, in which a plurality of pillars are arranged in parallel, wherein a space between the adjacent pillars of the second filter portion is narrower than a space between the adjacent pillars of the first filter portion.

### CROSS-REFERENCE TO RELATED APPLICATION

The present application is based on and claims the benefit of priority of Japanese Priority Application No. 2015-124866 filed on Jun. 22, 2015, the entire contents of which are hereby incorporated by reference.

### BACKGROUND OF THE INVENTION

1. Field of the Invention

The present invention relates to a filter system.

2. Description of the Related Art

For example, it is disclosed, in Patent Document 1, a flow channel substrate in which a micro flow channel including a filter system, a stirring system or the like, for example, is formed. Such a substrate is used for testing, inspection or the like of a very small amount of fluid. A structure of such a flow channel substrate including a suspending portion configured with a plurality of pillars and functioning as a filter to remove particles included in fluid flowing through the flow channel.

However, it is difficult for the structure disclosed in Patent Document 1 to handle particles with various sizes included in the fluid. So, as spaces between the pillars are blocked by the particles suspended by the pillars, the filter function is lowered and there is a limitation in a processable amount.

### PATENT DOCUMENT

[Patent Document 1] WO 2005/075975 A1

### SUMMARY OF THE INVENTION

The present invention is made in light of the above problems, and provides a filter system capable of handling various particles included in fluid and whose processable amount is increased.

According to an embodiment, there is provided a filter system provided in a flow channel through which fluid flows, including a first filter portion in which a plurality of pillars are arranged in parallel; and a second filter portion, provided downstream of the first filter portion in a flowing direction of the fluid, in which a plurality of pillars are arranged in parallel, wherein a space between the adjacent pillars of the second filter portion is narrower than a space between the adjacent pillars of the first filter portion.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a flow channel substrate of a first embodiment;

FIG. 2 is a view illustrating an example of a structure of a filter system of the first embodiment;

FIG. 3 is a cross-sectional view schematically illustrating an example of a structure of the filter system of the first embodiment;

FIG. 4 is a cross-sectional view schematically illustrating another example of a structure of the filter system of the first embodiment;

FIG. 5 is a cross-sectional view schematically illustrating another example of a structure of the filter system of the first embodiment;

FIGS. 6A and 6B are cross-sectional views schematically illustrating other examples of a structure of the filter system of the first embodiment, respectively;

FIG. 7 is a cross-sectional view schematically illustrating another example of a structure of the filter system of the first embodiment;

FIG. 8 is a cross-sectional view schematically illustrating another example of a structure of the filter system of the first embodiment;

FIGS. 9A and 9B are cross-sectional views schematically illustrating other examples of a structure of the filter system of the first embodiment, respectively;

FIG. 10 is a view illustrating an example of a structure of a filter system of a second embodiment;

FIG. 11 is a cross-sectional view schematically illustrating an example of a structure of the filter system of the second embodiment; and

FIG. 12 is a cross-sectional view schematically illustrating another example of a structure of the filter system of the second embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### First Embodiment

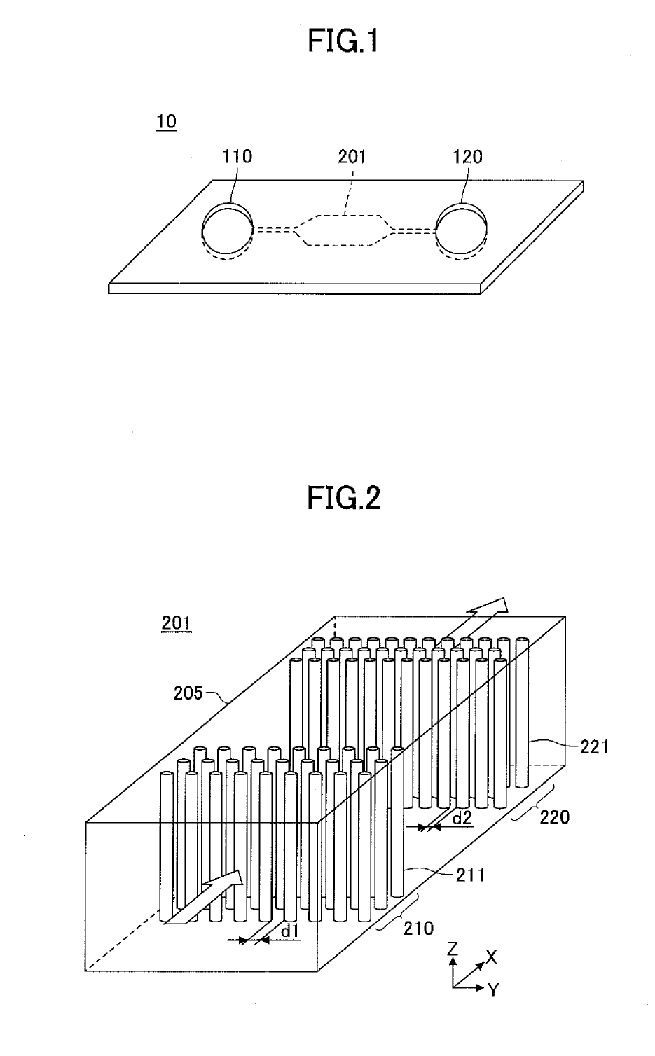

FIG. 1 is a view illustrating an example of a flow channel substrate 10 of a first embodiment. As illustrated in FIG. 1, the flow channel substrate 10 includes an inlet port 110, an outlet port 120, and a filter system 201.

The inlet port 110 is a circular shaped concave portion provided with an opening, at a upper surface side of the flow channel substrate 10 in FIG. 1, and a bottom surface. The inlet port 110 is formed at one end side of the flow channel substrate 10. Fluid used for inspection or the like is supplied to the inlet port 110.

The outlet port 120 is a circular shaped concave portion provided with an opening at the upper surface side of the flow channel substrate 10 in FIG. 1, and a bottom surface. The outlet port 120 is formed at the other end side of the flow channel substrate 10. The outlet port 120 communicates with the inlet port 110 through a flow channel that is formed inside the flow channel substrate 10. The fluid supplied to the inlet port 110 and flown through the flow channel is ejected from the outlet port 120.

The filter system 201 is formed at the flow channel that communicates between the inlet port 110 and the outlet port 120, and removes particles included in the fluid flowing through the flow channel. The structure of the filter system 201 is described later in detail.

In the flow channel substrate 10 having the above described structure, fluid used for inspection or the like is supplied to the inlet port 110, impurity particles or the like included in the fluid are removed by the filter system 201, and the fluid from which the impurity particles are removed is ejected from the outlet port 120.

The fluid supplied to the inlet port 110 is liquid including a food that is dissolved after being crushed or the like, for example. Particles of the food remaining in the liquid are removed by the filter system 201 after being supplied to the inlet port 110. The liquid from which the particles such as the food or the like are removed is ejected from the outlet port 120, and existence of substances in the food that cause an allergy, contamination or the like is inspected. Further, it is possible for the flow channel substrate 10 to remove unnecessary particles from gas, mixture of gas and liquid or the like as well.

The flow channel substrate 10 is formed by stacking a plurality of substrates each being formed by a die using a resin material, for example. Alternatively, the flow channel substrate 10 may be formed by stacking a plurality of glass substrates including a glass in which the filter system 201 or the like is formed by etching or the like, for example, or may be formed by other methods.

The structure of the flow channel substrate 10 is not limited to the example illustrated in FIG. 1. For example, in addition to the filter system 201, a system (mechanism) having various functions such as a dilution system, a stirring system or the like may be formed at the flow channel between the inlet port 110 and the outlet port 120 in the flow channel substrate 10.

Next, the filter system 201 formed in the flow channel substrate 10 is described in detail.

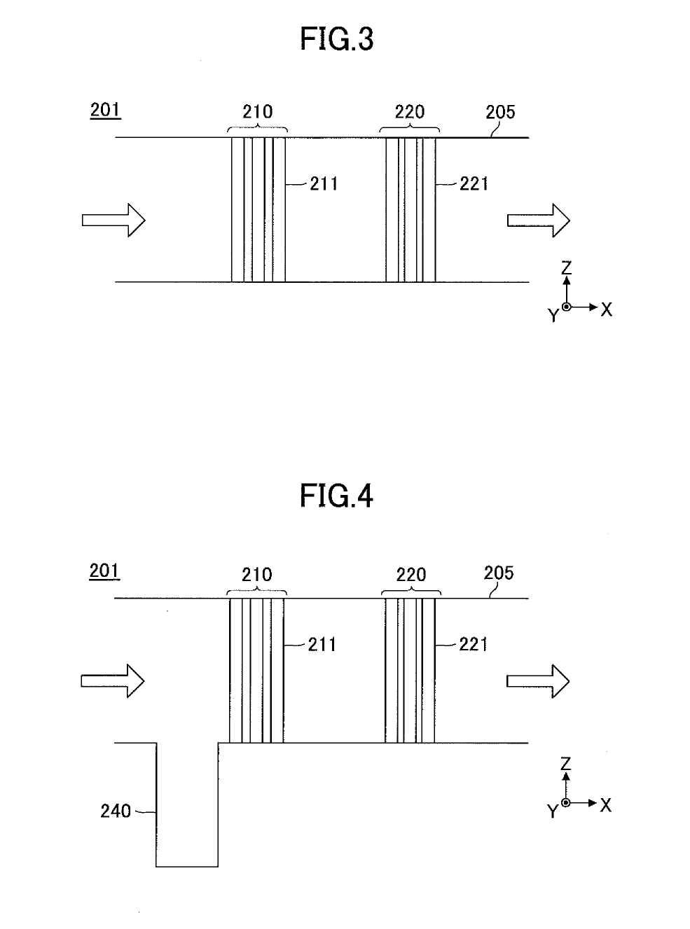

FIG. 2 is a view illustrating an example of a structure of the filter system 201 of the first embodiment. Further, FIG. 3 is a cross-sectional view in an XZ-plane schematically illustrating the filter system 201 illustrated in FIG. 2.

In the drawings, an X-direction is a direction that is parallel to a flowing direction of the fluid in the flow channel 205. Further, a Y-direction is a width direction of the flow channel 205. A Z-direction is a vertical direction and also a height direction of the flow channel 205. Further, in the drawings, the flowing direction of the fluid flowing through the flow channel 205 is indicated by arrows.

As illustrated in FIG. 2 and FIG. 3, the filter system 201 includes a first filter portion 210 and a second filter portion 220, and is formed at a flow channel 205 through which the fluid flows in the flow channel substrate 10.

The flow channel 205 of the embodiment is formed in a rectangular tube-like shape in a YZ plane where both the width in the Y-direction and the height in the Z-direction are 1 mm, for example. A sectional shape of the flow channel 205 in the YZ plane may be different shapes such as a circular shape, a polygonal shape or the like, for example.

The first filter portion 210 is configured with a plurality of pillars 211. Each of the pillars 211 is arranged such that its axial direction is in parallel to the Z-direction, and both ends are supported and fixed by inner wall surfaces of the flow channel 205. In the first filter portion 210, three rows of the pillars 211 are provided in the X-direction where each of the rows includes the pillars 211 arranged along the Y-direction such that a space between the adjacent pillars 211 in the Y-direction becomes a first space d1.

The second filter portion 220 is configured with a plurality of pillars 221, and is provided downstream of the first filter portion 210 in the flow channel 205. Each of the pillars 221 is arranged such that its axial direction is in parallel to the Z-direction, and both ends are supported and fixed by the inner wall surfaces of the flow channel 205. In the second filter portion 220, three rows of the pillars 221 are provided in the X-direction where each of the rows includes the pillars 221 arranged along the Y-direction such that a space between the adjacent pillars 221 in the Y-direction becomes a second space d2, which is narrower than the first space d1.

Although it is not limited, a space between the adjacent rows of the pillars 211 in the X-direction may also be the first space d1 and a space between the adjacent rows of the pillars 221 in the X-direction may also be the second space d2. Alternatively, the space between the adjacent rows of the pillars 211 and the space between the adjacent rows of the pillars 221 may be the same in the X-direction.

Here, the first filter portion 210 and the second filter portion 220 may include one or more rows of the pillars 211 and 221, respectively, and the number of rows of the pillars 211 and 221 for the first filter portion 210 and the second filter portion 220 may be different.

The diameter of each of the pillars 211 and 221 is 20 μm to 100 μm, for example, and the pillars 211 and 221 are arranged in parallel such that the space d1 or d2 between the adjacent pillars becomes 5 μm to 40 μm. Each of the pillars 211 and the pillars 221 may be a polygonal column or the like, however, preferably a circular column so that the fluid can easily flow.

Here, the pressure from the fluid flowing through the flow channel 205 toward the pillars 211 of the upstream first filter portion 210 is larger than that toward the pillars 221 of the downstream second filter portion 220. Thus, the diameter of each of the upstream pillars 211 may be larger than that of each of the downstream pillars 221 in order to endure the pressure from the fluid flowing through the flow channel 205, for example.

According to the above described filter system 201, the particles, whose diameters are larger than or equal to the particle diameter d1, included in the fluid flowing through the flow channel 205 are removed by the first filter portion 210, and further, the particles whose diameters are less than the particle diameter d1 and greater than or equal to the particle diameter d2, included in the fluid flowing through the flow channel 205 are removed by the second filter portion 220. As such, the fluid supplied to the inlet port 110 of the flow channel substrate 10 and introduced to the flow channel 205 is ejected from the outlet port 120 after the particles whose diameters are larger than or equal to the particle diameter d2 are removed by the filter system 201.

As such, the filter system 201 can remove various particles included in the fluid and having different particle diameters. Further, as the filter system 201 step-wisely processes particles with different particle diameters by the first filter portion 210 and the second filter portion 220, blocking occurs less and the larger amount of fluid can be processed, compared with a case in which the fluid is processed only by the second filter portion 220 whose space between the pillars 221 is narrow, for example.

As exemplified in FIG. 4, the filter system 201 may include a first hole portion 240 provided upstream of the first filter portion 210 at a lower side of the flow channel 205 in the vertical direction. The maximum width of the first hole portion 240 in the X-direction is 1 mm to 5 mm, and the depth of the first hole portion 240 in the Z-direction is 200 μm to 1 mm, for example. Although not illustrated in FIG. 4, the width of the first hole portion 240 in the Y-direction may be the same as that of the flow channel 205.

The particles included in the fluid flowing through the flow channel 205 fall down in the first hole portion 240 by gravity, for example, before reaching the first filter portion 210. Further, the particles suspended by the first filter portion 210 fall down in the first hole portion 240. Here, the particles whose particle diameters are smaller than the space d1 between the pillars 211 of the first filter portion 210 also fall down in the first hole portion 240 by gravity, or by colliding against the pillars 211 of the first filter portion 210, for example.

As such, as the particles included in the fluid flowing through the flow channel 205 fall down in the first hole portion 240 provided upstream of the first filter portion 210, the particles to be removed by the first filter portion 210 and the second filter portion 220 are decreased. Thus, according to the filter system 201, the larger amount of fluid can be processed at the first filter portion 210 and the second filter portion 220 without causing blocking.

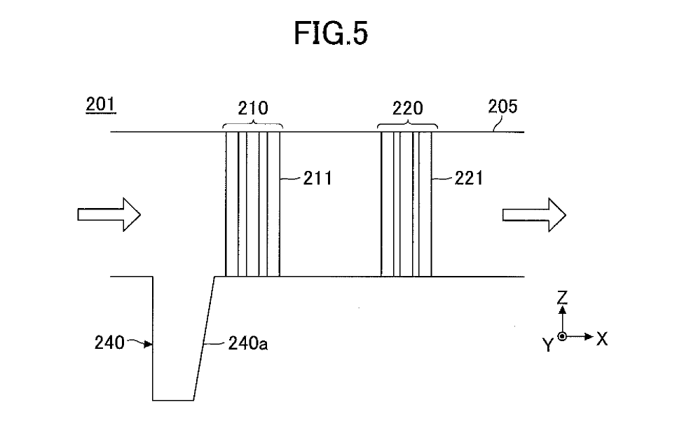

As illustrated in FIG. 5, a wall surface 240a of the first hole portion 240 at a first filter portion 210 side may be formed to be inclined with respect to the vertical direction such that a space of the first hole portion 240 in the X-direction gradually becomes larger in a upward direction. In other words, the wall surface 240a is inclined with respect to the vertical direction such that the first hole portion 240 is tapered in a downward direction.

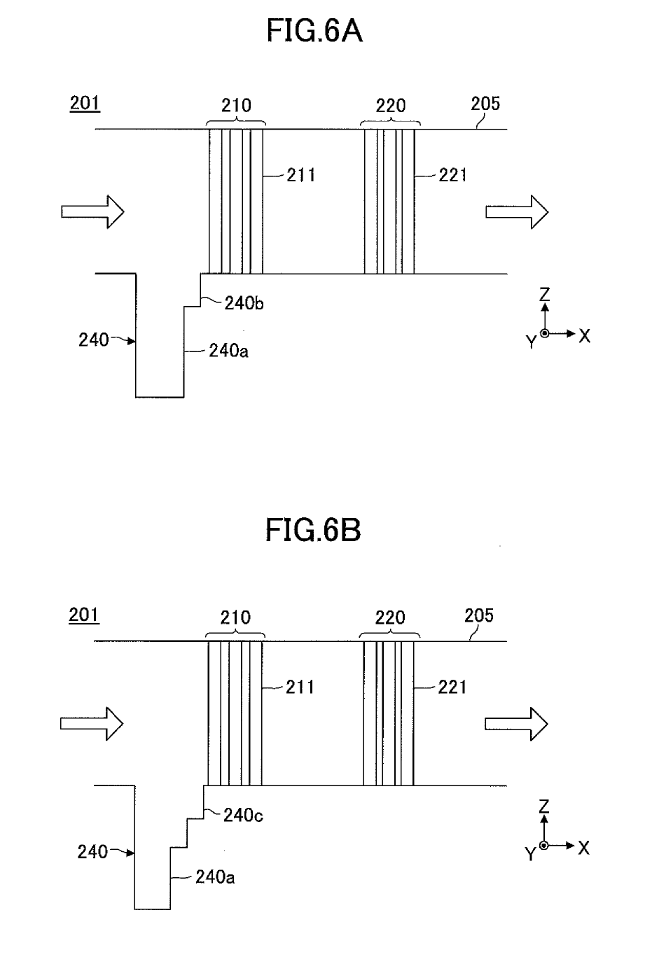

Further, as illustrated in FIG. 6A, a step portion 240b in a stepwise shape may be formed at the wall surface 240a of the first hole portion 240 at the first filter portion 210 side. As illustrated in FIG. 6B, a multistep step portion 240c may be formed at the wall surface 240a at the first filter portion 210 side.

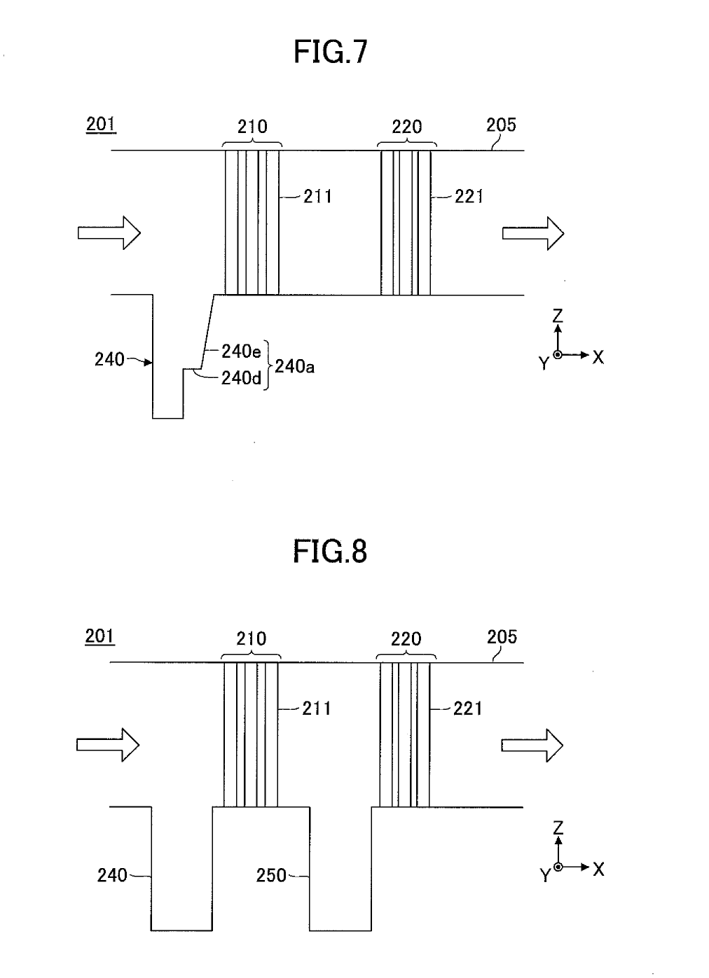

Further, as illustrated in FIG. 7, both a step portion 240d and an inclined surface 240e by which a space in the X-direction gradually becomes larger in a upward direction may be formed at the wall surface 240a of the first hole portion 240 at the first filter portion 210 side.

With the above described configurations illustrated in FIG. 5 to FIG. 7, particles whose particle diameters, specific gravities or the like are different are deposited at different positions in the Z-direction, for example, at the step portion 240b, 240c or 240d, or the inclined surface 240a or 240e formed at the wall surface of the first hole portion 240 at the first filter portion 210 side. Thus, it is possible to perform various analyses by collecting the particles deposited on the wall surface 240a, the step portion 240b, 240c or 240d, or the inclined surface 240e of the first hole portion 240 after flowing through the fluid.

Further, as illustrated in FIG. 8, the filter system 201 may include a second hole portion 250 provided between the first filter portion 210 and the second filter portion 220 in the X-direction at a lower side of the flow channel 205 in the vertical direction.

The particles included in the fluid flowing through the flow channel 205 and passed through the first filter portion 210 fall down in the second hole portion 250 by gravity, for example, before reaching the second filter portion 220. Further, the particles suspended by the second filter portion 220 fall down in the second hole portion 250. Here, the particles whose particle diameters are smaller than the space d2 between the pillars 221 of the second filter portion 220 also fall down in the second hole portion 250 by gravity, or by colliding against the pillars 221 of the second filter portion 220, for example.

As such, as the particles included in the fluid flowing through the flow channel 205 fall down in the second hole portion 250 provided between the first filter portion 210 and the second filter portion 220, the particles to be removed by the second filter portion 220 are decreased. Thus, according to the filter system 201, the larger amount of fluid can be processed at the second filter portion 220 without causing blocking.

Here, similar to the first hole portion 240, a step portion, an inclined surface or the like may be provided at a wall surface of the second hole portion 250 at a second filter portion 220 side, and the second hole portion 250 may have a shape different from that of the first hole portion 240.

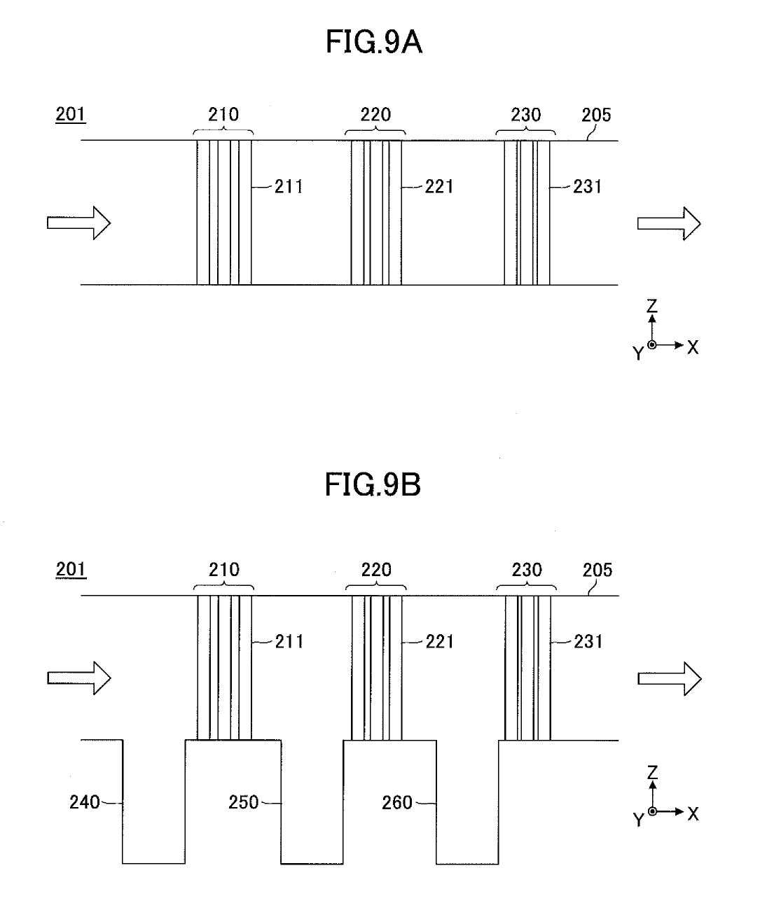

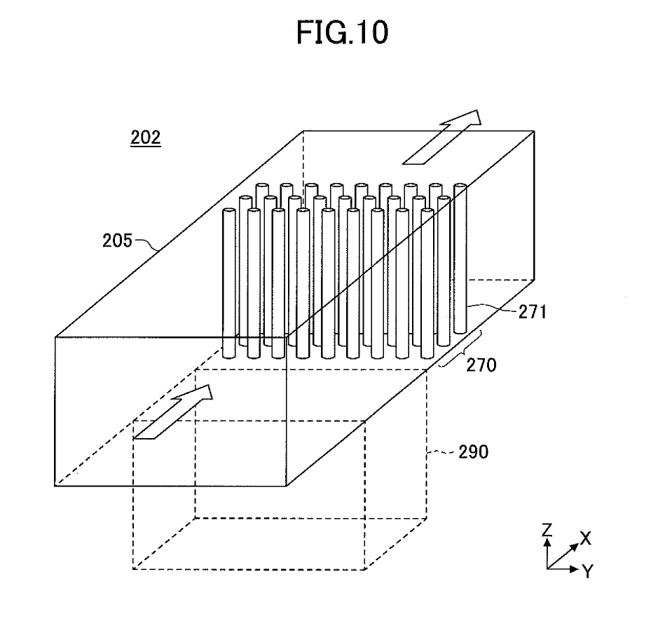

Further, as illustrated in FIG. 9A, the filter system 201 may include a third filter portion 230 configured with a plurality of pillars 231, and is provided downstream of the second filter portion 220. The pillars 231 may be arranged in parallel such that a space between the adjacent pillars 231 in the Y-direction is narrower than the space d2 of the pillars 221 of the second filter portion 220.

The filter system 201 can handle various particles with different particle diameters or the like, for example, by step-wisely removing the particles included in the fluid flowing through the flow channel 205 by the first filter portion 210, the second filter portion 220 and the third filter portion 230. Further, the processable amount of the fluid is increased by suppressing blocking at each of the filter portions 210, 220 and 230.

Further, as illustrated in FIG. 9B, the filter system 201 may include the first hole portion 240 provided upstream of the first filter portion 210, the second hole portion 250 provided between the first filter portion 210 and the second filter portion 220, and a third hole portion 260 provided between the second filter portion 220 and the third filter portion 230.

As the particles fall down in each of the hole portions 240, 250 and 260 by gravity or the like, the particles to be removed by each of the filter portions 210, 220 and 230 are decreased. Thus, according to the filter system 201, the larger amount of fluid can be processed without causing blocking at each of the filter portions 210, 220 and 230.

Here, the first hole portion 240, the second hole portion 250 and the third hole portion 260 may have shapes different from each other. Further, a step portion, an inclined surface or the like may be formed at a downstream side wall surface of at least one of the first hole portion 240, the second hole portion 250 and the third hole portion 260.

Further, the filter system 201 may include one or more filter portions provided downstream of the third filter portion 230 in the flow channel 205 where each of the filter portions is configured with a plurality of pillars arranged in parallel such that a space between the adjacent pillars is narrower than that in the upstream filter portion. Further, the filter system 201 may include one or more hole portions each provided upstream of the one or more filter portions, respectively, at a lower side of the flow channel 205 in the vertical direction.

Here, the plurality of pillars that compose the filter portion provided in the filter system 201 may be arranged in parallel such that an axial direction of each of the pillars is inclined with respect to the Z-direction, for example. Alternatively, the plurality of pillars that compose the filter portion provided in the filter system 201 may be arranged in parallel such that an axial direction of each of the pillars is in parallel to the Y-direction, for example. In this case, a space between the adjacent pillars in the Z-direction becomes the first space d1, the second space d2 or the like.

Further, it is preferable that each of the hole portions of the filter system 201 is provided upstream of the filter portion without having a space between the respective filter portion. With this configuration, the particles suspended by the filter portion easily fall down in the respective hole portion, and the processable amount of the fluid by the filter system 201 is increased by suppressing blocking at the filter portion. Further, each of the hole portions provided in the filter system 201 may be formed such that it concaves in a direction inclined with respect to the Z-direction, for example.

As described above, in the filter system 201 of the first embodiment, the particles included in the fluid flowing through the flow channel 205 are removed by the plurality of filter portions, each including a plurality of pillars arranged in parallel, configured such that spaces between adjacent pillars are different from each other. As the filter system 201 includes the plurality of filter portions that are configured such that the spaces between the adjacent pillars are different from each other, it is possible to handle various particles included in the fluid and having different particle diameters. Further, according to the filter system 201, as the particles with different particle diameters are step-wisely processed by the plurality of filter portions, the processable amount of the fluid is increased by reducing blocking at each of the filter portions.

### Second Embodiment

Next, the second embodiment is described with reference to the drawings. Explanations are not repeated for the components already explained in the previous embodiment.

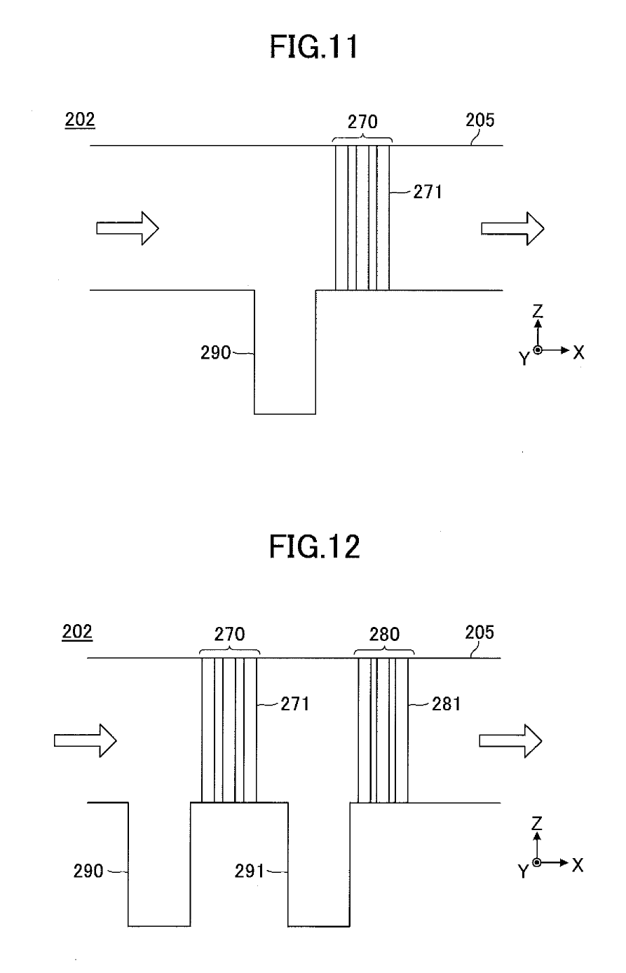

FIG. 10 is a view illustrating an example of a filter system 202 of the second embodiment. Further, FIG. 11 is a cross-sectional view in the XZ-plane schematically illustrating the filter system 202 illustrated in FIG. 10.

As illustrated in FIG. 10 and FIG. 11, the filter system 202 includes a first filter portion 270 and a first hole portion 290. Similar to the filter system 201 of the first embodiment, the filter system 202 is formed at the flow channel 205 of the flow channel substrate 10 that communicates between the inlet port 110 and the outlet port 120.

The first filter portion 270 is configured with a plurality of pillars 271. The diameter of each of the pillars 271 is 20 μm to 100 μm, for example, each of the pillars 271 is arranged such that its axial direction is in parallel to the Z-direction, and both ends are supported and fixed by the inner wall surfaces of the flow channel 205. In the first filter portion 270, three rows of the pillars 271 are provided in the X-direction where each of the rows includes the pillars 271 arranged along the Y-direction such that a space between the adjacent pillars 271 in the Y-direction becomes a predetermined size of 5 μm to 40 μm, for example. Here, the first filter portion 270 includes at least such a row of pillars 271. Further, although the pillar 271 of the embodiment is a circular column, the pillar 271 may be a polygonal column.

The first hole portion 290 is provided upstream of the first filter portion 270 in the flow channel 205 at a lower side of the flow channel 205 in the vertical direction. The maximum width of the first hole portion 290 in the X-direction is 1 mm to 5 mm, and the depth of the first hole portion 290 in the Z-direction is 200 μm to 1 mm, for example.

The particles included in the fluid flowing through the flow channel 205 fall down in the first hole portion 290 by gravity, for example, before reaching the first filter portion 27b. Further, the particles suspended by the first filter portion 270 fall down in the first hole portion 290. Here, the particles whose particle diameters are smaller than the space between the pillars 271 of the first filter portion 270 also fall down in the first hole portion 290 by gravity, or by colliding against the pillars 271 of the first filter portion 270, for example.

As such, various particles included in the fluid flowing through the flow channel 205 can be removed by the first filter portion 270 and the first hole portion 290 in the filter system 202. Further, as the particles included in the fluid fall down in the first hole portion 290 provided upstream of the first filter portion 270, the particles to be removed by the first filter portion 270 are decreased. Thus, according to the filter system 202, the larger amount of fluid can be processed without causing blocking at the filter portion 270.

Further, as illustrated in FIG. 12, the filter system 202 may include a second filter portion 280 configured with a plurality of pillars 281 arranged in parallel, in which a space between the adjacent pillars 281 is smaller than the space between the pillars 271 of the first filter portion 270, provided downstream of the first filter portion 270.

The filter system 202 can handle various particles with different particle diameters or the like, for example, by step-wisely removing the particles included in the fluid flowing through the flow channel 205 by the plurality of filter portions 270 and 280. Further, the processable amount of the fluid is increased by suppressing blocking at each of the filter portions 270 and 280.

Further, as illustrated in FIG. 12, the filter system 202 may include a second hole portion 291 provided between the first filter portion 270 and the second filter portion 280 at a lower side of the flow channel 205 in the vertical direction.

The particles included in the fluid flowing through the flow channel 205 and passed through the first filter portion 270 fall down in the second hole portion 291 by gravity, for example, before reaching the second filter portion 280. Further, the particles suspended by the second filter portion 280 fall down in the second hole portion 291. Here, the particles whose particle diameters are smaller than the space between the pillars 281 of the second filter portion 280 also fall down in the second hole portion 291 by gravity, or by colliding against the pillars 281 of the second filter portion 280, for example.

As such, as the particles included in the fluid flowing through the flow channel 205 fall down in the second hole portion 291 provided between the first filter portion 270 and the second filter portion 280, the particles to be removed by the second filter portion 280 are decreased. Thus, according to the filter system 202, the larger amount of fluid can be processed without causing blocking at the second filter portion 280.

Here, the first hole portion 290 and the second hole portion 291 may have different shapes. Further, at least for one of the first hole portion 290 and the second hole portion 291, similar to the first hole portion 240 of the first embodiment, a step portion, an inclined surface or the like may be formed at a wall surface at a downstream side, for example.

Further, the filter system 202 may include one or more filter portions provided downstream of the second filter portion 280 each being configured with a plurality of pillars arranged in parallel such that a space between the adjacent pillars becomes narrower than a space between the adjacent pillars of the upstream filter portion in the flow channel 205. Further, the filter system 202 may include one or more hole portions each provided upstream of the one or more filter portions, respectively, at a lower side of the flow channel 205 in the vertical direction.

Here, the plurality of pillars that compose the filter portion provided in the filter system 202 may be arranged in parallel such that an axial direction of each of the pillars is inclined with respect to the Z-direction, for example. Alternatively, the plurality of pillars that compose the filter portion provided in the filter system 202 may be arranged in parallel such that an axial direction of each of the pillars is in parallel to the Y-direction. Further, it is preferable that each of the hole portions of the filter system 202 is provided upstream of the filter portion without having a space between the respective filter portion. With this configuration, the particles suspended by the filter portion easily fall down in the respective hole portion, and the processable amount of the fluid by the filter system 202 increases by suppressing blocking at the filter portion. Further, the hole portion provided in the filter system 202 may be formed such that it concaves in a direction inclined with respect to the Z-direction, for example.

As described above, in the filter system 202 of the second embodiment, the particles included in the fluid flowing through the flow channel 205 are removed by the first filter portion 270 and the first hole portion 290. As the filter system 202 is capable of removing the particles whose particle diameters are greater than or equal to the space between the pillars 271 by the first filter portion 270, and also capable of removing the particles whose particle diameters are less than the space between the pillars 271 by the first hole portion 290, the filter system 202 is adaptable for various particles. Further, as the particles included in the fluid fall down in the first hole portion 290 by gravity or by colliding against the pillars 271 of the first filter portion 270, for example, the processable amount of the fluid is increased without causing blocking at the first filter portion 270.

According to the embodiment, a filter system capable of handling various particles included in fluid and whose processable amount is increased is provided.

Although a preferred embodiment of the filter system has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

What is claimed is:

1. A filter system provided in a flow channel through which fluid flows, comprising:
a first filter portion in which a plurality of pillars are arranged in parallel; and
a second filter portion, provided downstream of the first filter portion in a flowing direction of the fluid, in which a plurality of pillars are arranged in parallel,
wherein a space between the adjacent pillars of the second filter portion is narrower than a space between the adjacent pillars of the first filter portion.

2. The filter system according to claim 1, further comprising a first hole portion provided upstream of the first filter portion in the flowing direction at a downward side of the flow channel in a vertical direction.

3. The filter system according to claim 2,
wherein a wall surface of the first hole portion at a filter portion side is formed to be inclined with respect to a vertical direction such that a space in the flowing direction gradually becomes larger in a upward direction.

4. The filter system according to claim 2,
wherein a step is provided at a wall surface of the first hole portion at a first filter portion side.

5. The filter system according to claim 1, further comprising a second hole portion provided between the first filter portion and the second filter portion in the flowing direction at a downward side of the flow channel in the vertical direction.

6. A filter system provided in a flow channel through which fluid flows, comprising:
a filter portion in which a plurality of pillars are arranged in parallel; and
a hole portion provided upstream of the filter portion in a flowing direction of the fluid at a downward side of the flow channel in a vertical direction.

7. The filter system according to claim 6,
wherein a wall surface of the hole portion at a filter portion side is formed to be inclined with respect to a vertical direction such that a space in the flowing direction becomes larger upwardly in the vertical direction.

8. The filter system according to claim 6,
wherein a step is provided at a wall surface of the hole portion at a filter portion side.

9. The filter system according to claim 1,
wherein the fluid is liquid containing particles composed of a food.

10. The filter system according to claim 6,
wherein the fluid is liquid containing particles composed of a food.
